(19) United States
(12) Patent Application Publication
(10) Pub. No.: US 2008/0006135 A1
(43) Pub. Date: Jan. 10, 2008

(54) I-joist cutting jig

(76) Inventor: Thomas Desmet, Hampstead, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 11/483,895

(22) Filed: Jul. 10, 2006

(51) Int. Cl. B27B 21/00

(52) U.S. Cl. 83/745; 83/574

(57) ABSTRACT

An I-joist jig for cutting a composite I-joist using a circular saw or the like features a support base and a handle. The support base includes an upper surface having a shoulder disposed along an edge forming a guide and a planar region disposed adjacent to the shoulder. A bottom surface of the support base feature a protrusion that is generally perpendicular to the shoulder. In use, support base is placed on the I-joist such that the I-joist jig spans across the ends of the I-joist and over the central region. The protrusion is aligned against an end of the I-joist thereby aligning the shoulder of the I-joist jig and providing a guiding surface for the circular saw.

### TECHNICAL FIELD

The present invention relates to construction and more particularly, relates to a jig for cutting wooden or composite I-joists.

### BACKGROUND INFORMATION

Laminated or composite I-joists 1, FIG. 1, have become increasingly popular in recent times. These I-joists a typically manufactured from plywood, particle board, or the like and feature a top and bottom generally parallel support surface 2, 3 separated by a central support 4. The central support is 4 arranged substantially perpendicular to the top and bottom support surfaces 2, 3, generally in the middle of the top and bottom surface 2, 3. As is well k known, the strength of these I-joist 1 is determined largely based on the height and thickness of the central support 4.

I-joists 1 are typically used to span large distances. Because the I-joists 1 are manufactured, long I-joist 1 can be sold for substantially less compared to natural wooden joists. Additionally, the overall weight of the I-joists is generally substantially less compared to a natural, wooden joist or metal I-beams making the use of I-joists substantially easier and safer.

While I-joists offer numerous benefits compared to natural wooden joist and metal I-beams, they are difficult to cut. The difficulty in cutting the I-joists results largely from the shape of the I-joists, the height H of the I-joists, and the radius of the generally available handheld saws.

I-joists typically have a height H significantly larger than their width W. For example, a typical I-joist has a height H ranging between approximately 7.5″ to approximately 16″ while the width W is typically 3.5″ at the most. The most common hand tool for used for cutting in the construction industry is the circular saw 5. As is well known, a circular saw must be placed upon a substantially planar surface in order to cut accurately and safety. Due to the height and shape of I-joists and the limited cutting radius of the circular saw (which is often less than 6″), cutting the I-joist along the top and bottom surfaces 2, 3 often does not result in cutting the entire central region 4.

In the past, workers have cut blocks 6, FIG. 2, sized to fit within the channels 7 formed by central support surface 4 and the top and bottom support surfaces. Using the blocks, the circular saw 5 can be placed on the block 6 and the I-joists 1 can be cut in a single pass. While the use of the blocks 6 is generally effective, it suffers from several problems.

First, blocks 6 must be created for the various I-joists 1 because the size (depth as well as length) of the channels 7 varies greatly among I-joists 1. This is a time consuming process. Additionally, a worker must generally hold the block 6 in place with his/her hand to prevent the block from shifting during use and is a safety hazard. The blocks 6 are easily lost or mistaken for scrap and thrown away. Finally, the blocks 6 do not provide any guiding or fencing surfaces to help guide the saw 5 and ensure a straight and even cut. As a result, cuts made using the blocks 6 are often not straight or even, making the installation of the I-joist 1 difficult or impossible.

Accordingly, what is a method and needed is a device for easily cutting I-joists. The method and device should preferable allow the I-joist to be cut in a single pass. Additionally, the method and device should preferable work with a wide variety of I-joist sizes and dimensions. Finally, the method and device should preferable increase the worker's safety and should preferable provide a guiding or fencing surface to aid in making a straight cut.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the following claims.

### SUMMARY

According to one embodiment, the present invention features an I-joist jig comprising a support base and a handle extending generally perpendicularly outwardly from the first edge of the support base. The support base has a longitudinal axis and an upper and lower surface and preferably has a length sufficient to span between an upper and a lower surface of an I-joist. The upper surface includes a first shoulder disposed substantially parallel to the longitudinal axis proximate a first edge of the support base and extends generally perpendicularly upwards from the upper surface. A substantially planar region is disposed adjacent to the first shoulder and is preferably sized and shaped to support at least part of a saw. The lower surface includes a second shoulder disposed substantially perpendicular to the longitudinal axis proximate a second edge of the support base. The second shoulder is preferably disposed proximate a first end region of the support base.

The second shoulder may be integral to the handle. Alternatively, the handle may be is disposed between the first shoulder and a second end region of the support base. The second end region is disposed about a substantially opposite end of the support base. The second shoulder may optionally be moveable with respect to the first shoulder. In a preferred embodiment, an end region of the second shoulder is moveable between an extended position wherein the end region of the second shoulder is disposed beyond an second edge region of the support base and a retracted position wherein the end region of the second shoulder is substantially aligned with the second end region of the support base.

According to another embodiment, the present invention features an I-joist jig for cutting an I-joist. The I-joist has an upper and a lower surface and a central surface disposed between the upper and the lower surfaces. The I-joist jig includes a substantially planar support surface. A first shoulder extends generally perpendicularly upwards from the planar support surface along a first edge of the planar support surface and a second shoulder extends generally perpendicularly downwards from the planar support surface. A handle extends outwardly from the first shoulder in a plane that is substantially parallel to a plane of the planar support surface. According to yet another embodiment, the present invention features an I-joist jig for cutting an I-joist having an upper and a lower surface and a central surface disposed between the upper and the lower surfaces. The I-joist jig features a support base including a substantially planar upper region, means for guiding a saw along a longitudinal axis of the substantially planar upper region (preferably a shoulder disposed along a first edge region of support base proximate the substantially planar upper region), and means for aligning the I-joist jig relative to the upper or lower surfaces of the I-joist (preferably a protrusion extending generally downwardly and away from the shoulder proximate a second end region of the support base). A handle extends generally perpendicularly outwardly from the support base. The I-joist jig optionally features means for adjusting a distance between the shoulder and a distalmost edge from the shoulder.

### BRIEF DESCRIPTION OF THE DRAWINGS

These and other features and advantages of the present invention will be better understood by reading the following detailed description, taken together with the drawings wherein:

FIG. 1 is an end view of one embodiment illustrating the difficulties of cutting an I-joist according to the prior art;

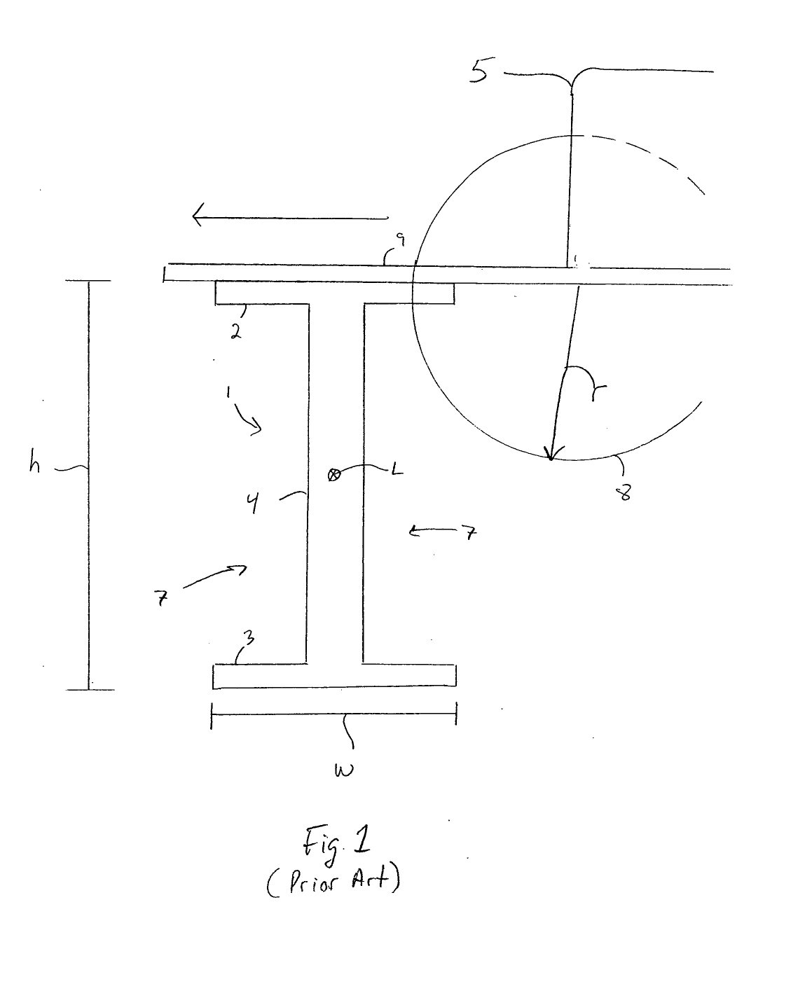

FIG. 2 is an end view of one embodiment of the prior art for cutting an I-joist;

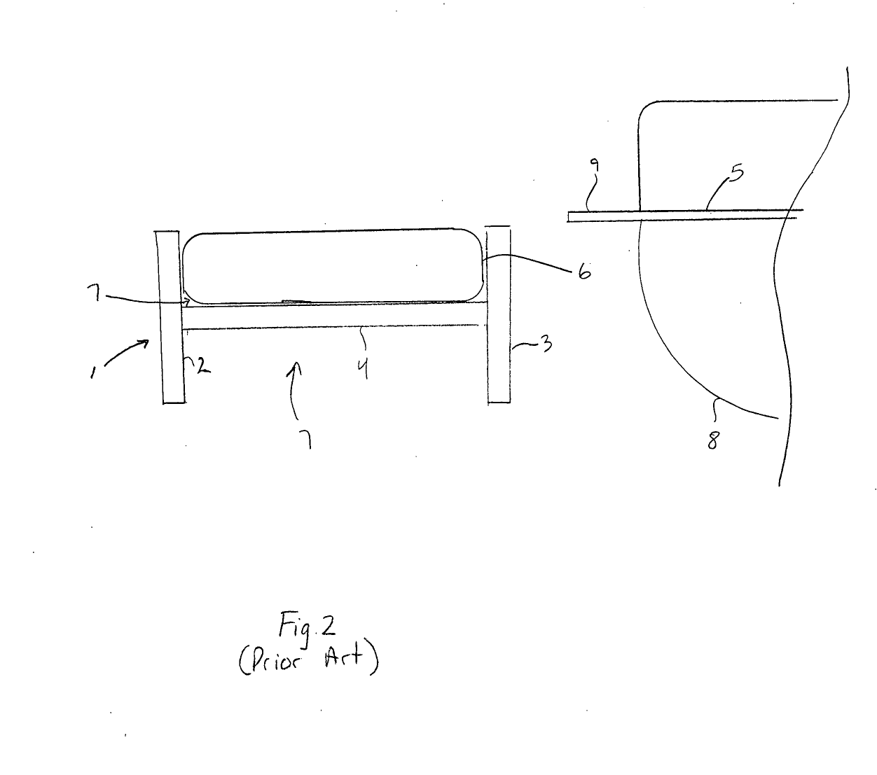

FIG. 3 is a perspective view of one embodiment of the I-joist jig according to the present invention;

FIG. 4 is an end view of the I-joist jig shown in FIG. 3 in combination with an I-joist according to the present invention;

FIG. 5 is a top perspective view of another embodiment of the I-joist jig according to the present invention; and

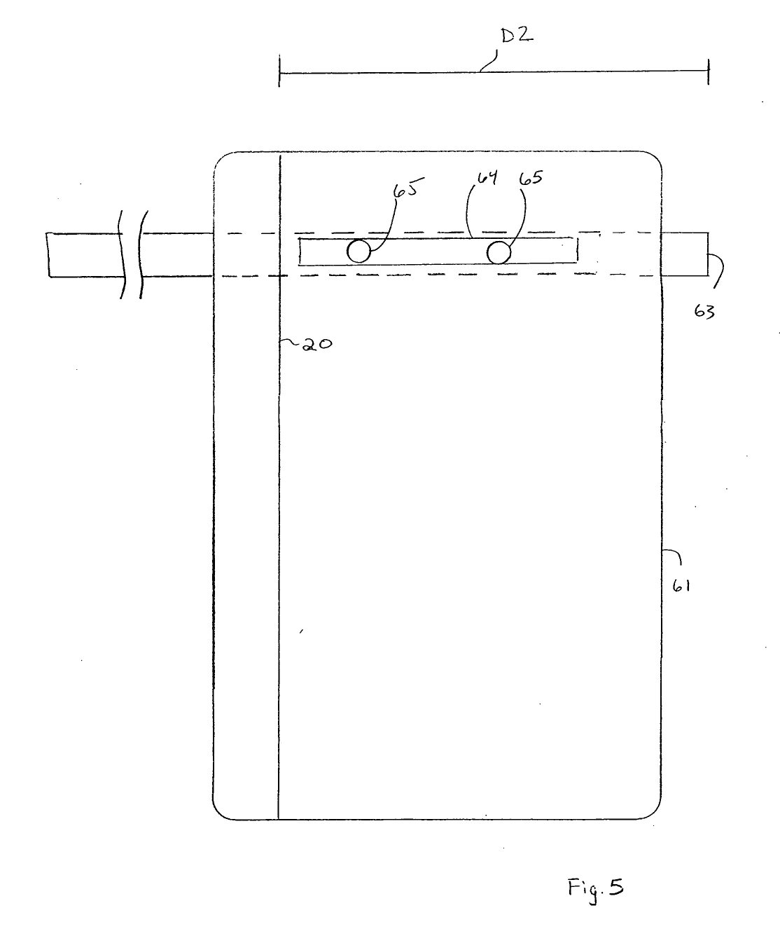

FIG. 6 is a top perspective view of yet another embodiment of the I-joist jig according to the present invention.

### DETAILED DESCRIPTION OF THE PREFERRED EMBODIMENTS

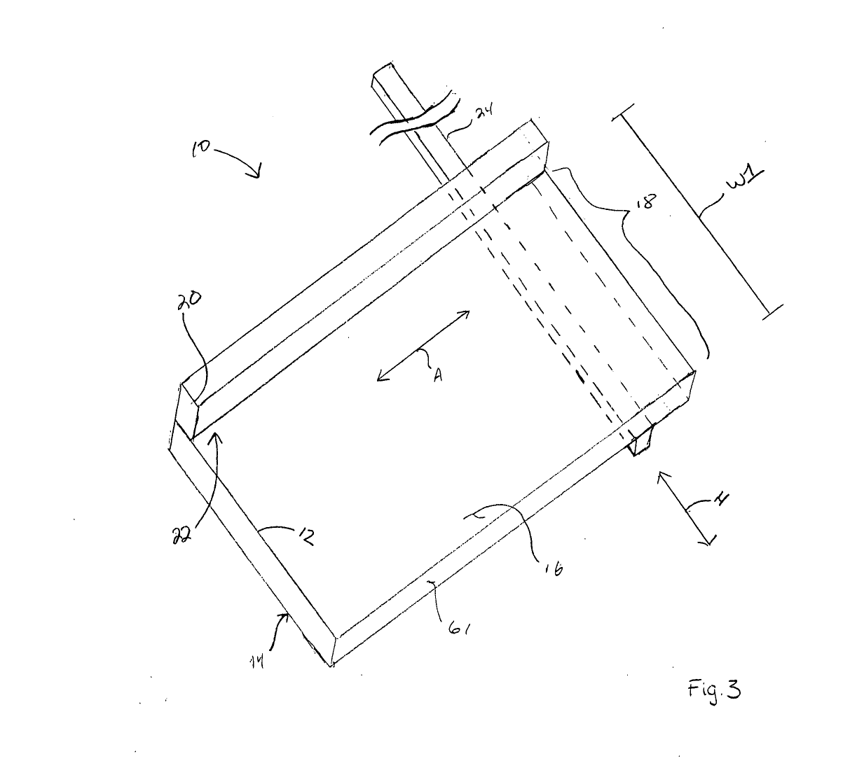

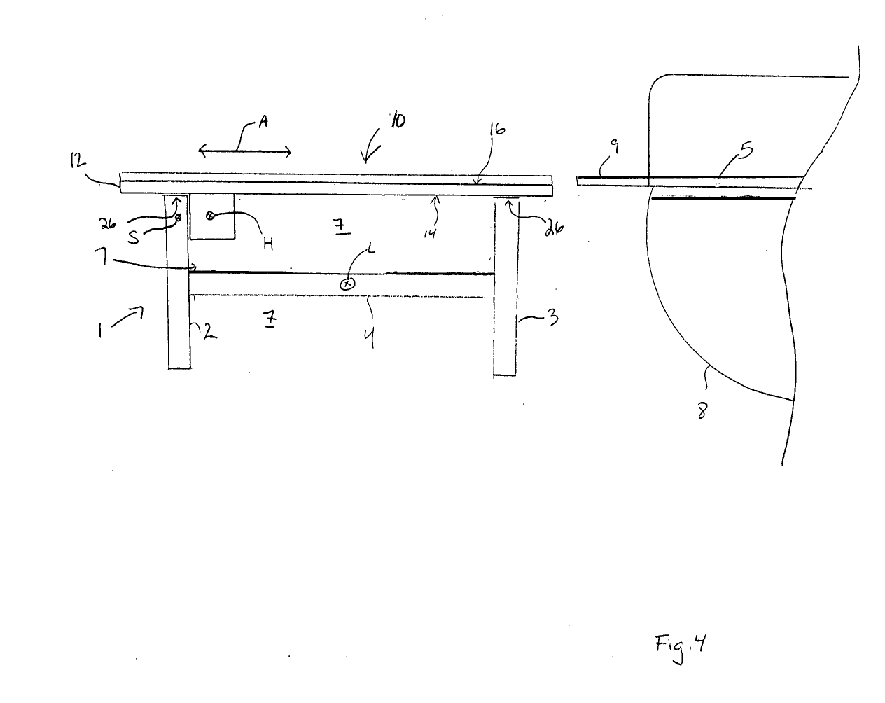

An I-joist jig or frame 10, FIG. 3, is particularly suited for cutting an I-joist 1, FIG. 4. As will be explained in greater detail hereinbelow, the I-joist jig 10 according to the present invention allows an I-joist 1 to be easily cut using a circular saw 5 or the like by providing a planar support surface to run the saw 5 over the channels 7 of the I-joist 1. As explained above, an I-joist 1 is typically manufactured from plywood, particle board, or the like and features a top and bottom generally parallel support surface 2, 3 separated by a central support 4. The central support 4 is arranged substantially perpendicular to the top and bottom support surfaces 2, 3, generally in the middle of the top and bottom surface 2, 3.

According to one embodiment, the I-joist jig 10, FIG. 3, features a support base 12 having a lower and an upper surface 14, 16. The lower surface 14 features a handle 24 extending outwardly along an axis H that is generally perpendicular to the longitudinal axis A of the support base 12. The handle 24 may be permanently secured to the support base 12 of the I-joist jig 10 or alternatively the handle 24 may be moveable relative to the support base 12 such that the support base 12 may move along the longitudinal axis H of the handle 24. The upper surface 16 of the support base 12 preferably features a generally planar region 18 and a shoulder 20 extending generally perpendicularly upwardly from the plane of the upper surface 14 along a first edge 22 thereof. The upper surface 14 preferably has a width W1 that is approximately the same as the distance D1 between the blade 8 of a circular saw 5 and the outer edge of the circular saw frame 9.

Referring specifically to FIG. 4, the support base 12 of the I-joist jig 10 sized and shaped such that when placed on the I-joist 1, the lower surface 14 contacts the ends 26 of the top and bottom surface 2, 3 of the I-joist 1. For illustrative purposes only, the support base 12 is preferably approximately 6 inches wide and approximately 16 inches long. Other sizes are also possible and are considered within the scope of the present invention.

In use, the I-joist jig 10 is placed across the I-joist 1 proximate the area to be cut as shown in FIG. 4 such that the I-joist jig 10 is substantially supported by the edges of the top and bottom surfaces 2, 3 of the I-joist 1. At least a portion of the handle 24 is aligned with the either the top or bottom surfaces 2, 3 of the I-joist 1 (preferably proximate an edge of the top/bottom surfaces 2, 3) such that the axis H of the handle 24 is substantially parallel to the axis S of the top or bottom surfaces 2, 3 of the I-joist 1. When the handle 24 is aligned in this position with respect to the top or bottom surfaces 2, 3, the shoulder 20 of the top upper surface 16 of the I-joist jig 10 is aligned substantially perpendicular to the longitudinal axis L of the I-joist 1 and the axis S of the top and bottom surfaces 2, 3.

Once the I-joist jig 10 is aligned as described above and shown in FIG. 4, the user holds the I-joist jig 10 in place by grasping on part of the handle 24. Next, the user places a saw 5 (such as a circular saw or the like) onto the generally planar region 18 of the upper surface 16 and aligns an outer edge of the frame 9 of the saw 5 with the shoulder region 20. The I-joist jig 10 is placed on the I-joist 1 such that the blade 8 of the saw 5 is aligned where the cut is to be made. The user then moves the saw 5 along the generally planar region 18 of the upper surface 16 in the direction of arrow A (FIG. 4) using the shoulder region 20 as a guide to keep the saw 5 straight. Because the should region 20 is perpendicular to the longitudinal axis L of the I-joist 1, the saw 5 cuts the I-joist 1 substantially perpendicular to the longitudinal axis L of the I-joist 1 as the saw 5 is guided along the shoulder region 20. Also, the user's hand is disposed away from the saw 5 since the user only needs to grasps the I-joist jig 10 on the handle 24 which extends outwardly from the I-joist jig 10.

As discussed above, the substantially planar region 18 of the I-joist jig 10 preferably has a width W1 that is approximately the same as the distance D1 between the saw blade 8 and the outer edge of the frame 9. When the width W1 is the same as the distance D1, the outer edge 61 of the I-joist jig 10 is preferably aligned substantially where the cut is to be made. However, because of the wide variations in distances D1 among different saws 5, the I-joist jig 10 according to the present invention preferably features an adjustment mechanism that allows the distance D2 between the outer edge 63 of the I-joist jig 10 and the should region 20 to be adjusted for different distances D1 among different saws 5. By adjusting distance D2, the user can simply align the outer edge 63 of the I-joist jig 10 where the cut is to be made regardless of the particular dimensions of the saw 5.

According to the exemplary embodiment, the adjustment mechanism preferably features a handle 24 that is moveable with respect to the shoulder region 20. In use, the position of the handle 24 is set such that the distance D2 between the shoulder region 20 and the outer edge 63 is approximately equal to distance D1. The outer edge 63 of the handle 24 preferably extends outwardly beyond the edge 61 of the support base 12 but is at least aligned with the outer edge 61 of the support base 12. Once the distance D2 is set, the outer edged 63 of the handle 24 is preferably aligned where the cut in the I-joist 1 is to be made.

The handle 24 preferably moves within a slot or groove 64 in the support base 12, and is preferably secured in place with one or more set screws or the like 65. The handle 24 and the support base 12 may optionally feature a dovetail arrangement or the like.

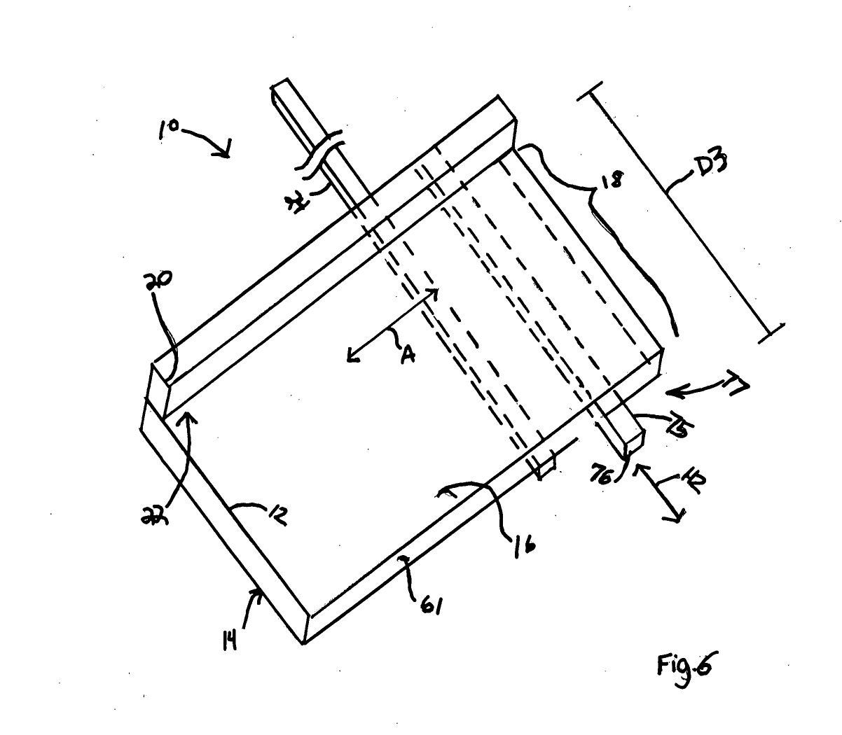

While the I-joist jig 10 has been described where the handle 24 is aligned with the top or bottom surface 2, 3 of the I-joist 1, this is not a limitation of the present invention. Referring specifically to FIG. 6, the I-joist jig 10 may feature a shoulder 75 disposed proximate an edge 77 of the support base 12 and extending generally perpendicularly downward from the bottom surface 14 of the support base 12 along a longitudinal axis H2 that is substantially perpendicular to axis A. This shoulder 75 may be moveable as described above with respect to the handle 24 such the distance D3 between the shoulder region 20 and the outer edge 76 of the shoulder 75 is approximately equal to distance D1. In use, the shoulder 75 is aligned with the top or bottom surfaces 2, 3 as described above and the outer edge 76 is aligned where the cut is to be made in the I-joist 1.

Additionally, while the support base 12 has been described as being perpendicular to the handle 24 and/or shoulder 75, this is not a limitation of the present invention unless specifically claimed as such. The present invention may also feature a tilting and/or pivoting device that allows the support surface 12 to be at an angle other than 90 degrees relative to the handle 24 and/or shoulder 75.

Accordingly, the present invention features a device and method for easily cutting an I-joist. The method and device allows the I-joist to be cut in a single pass and works with a wide variety of I-joist and saw sizes and dimensions. The method and device also increases the worker's safety and provides a guiding or fencing surface to aid in making a straight cut.

As mentioned above, the present invention is not intended to be limited to a system or method which must satisfy one or more of any stated or implied object or feature of the invention and should not be limited to the preferred, exemplary, or primary embodiment(s) described herein. The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the claims when interpreted in accordance with breadth to which they are fairly, legally and equitably entitled.

The invention claimed is:

1. An I-joist jig comprising:
a support base having a longitudinal axis, said support base further including:
an upper surface having:
a first shoulder disposed substantially parallel to said longitudinal axis proximate a first edge of said support base and extending generally perpendicularly upwards from said upper surface; and
a substantially planar region disposed adjacent to said first shoulder; and
a lower surface having a second shoulder disposed substantially perpendicular to said longitudinal axis proximate a second edge of said support base and extending generally perpendicularly downwards from said lower surface; and
a handle extending generally perpendicularly outwardly from said first edge of said support base.

2. The I-joist jig as claimed in claim 1 wherein said support base includes a length sufficient to span between an upper and a lower surface of an I-joist.

3. The I-joist jig as claimed in claim 2 wherein said planar region is sized and shaped to support at least part of a saw.

4. The I-joist jig as claimed in claim 1 wherein said second shoulder is disposed proximate a first end region of said support base.

5. The I-joist jig as claimed in claim 4 wherein said second shoulder is integral to said handle.

6. The I-joist jig as claimed in claim 4 wherein said handle is disposed between said first shoulder and a second end region of said support base wherein said second end region is disposed about a substantially opposite end of said support base.

7. The I-joist jig as claimed in claim 1 wherein said second shoulder is moveable with respect to said first shoulder.

8. The I-joist jig as claimed in claim 7 wherein an end region of said second shoulder is moveable between an extended position wherein said end region of said second shoulder is disposed beyond an second edge region of said support base and a retracted position wherein said end region of said second shoulder is substantially aligned with said second end region of said support base.

9. An I-joist jig for cutting an I-joist having an upper and a lower surface and a central surface disposed between said upper and said lower surfaces, said I-joist jig comprising:
a substantially planar support surface;
a first shoulder extending generally perpendicularly upwards from said planar support surface along a first edge of said planar support surface;
a second shoulder extending generally perpendicularly downwards from said planar support surface; and
a handle extending outwardly from said first shoulder in a plane that is substantially parallel to a plane of said planar support surface.

10. The I-joist jig as claimed in claim 9 wherein said planar support surface is sized and shaped to support at least part of a saw.

11. The I-joist jig as claimed in claim 10 wherein said second shoulder is disposed proximate a first end region of said planar support surface.

12. The I-joist jig as claimed in claim 9 wherein said second shoulder is integral to said handle.

13. The I-joist jig as claimed in claim 9 wherein said handle is disposed between said first shoulder and a second end region of said planar support surface wherein said second end region is disposed about a substantially opposite end of said planar support surface.

14. The I-joist jig as claimed in claim 9 wherein said second shoulder is moveable with respect to said first shoulder.

15. The I-joist jig as claimed in claim 9 wherein said second shoulder extends substantially perpendicularly to a longitudinal axis of said first shoulder.

16. The I-joist joist jig as claimed in claim 9 wherein an angle between said second shoulder and a longitudinal axis of said first shoulder is adjustable.

17. An I-joist jig for cutting an I-joist having an upper and a lower surface and a central surface disposed between said upper and said lower surfaces, said I-joist jig comprising:
a support base including:
a substantially planar upper region;
means for guiding a saw along a longitudinal axis of said substantially planar upper region; and
means for aligning said I-joist jig relative to said upper or lower surfaces of said I-joist; and
a handle extending generally perpendicularly outwardly from said support base.

18. The I-joist jig as claimed in claim 17 wherein said means for guiding includes a shoulder disposed along a first edge region of support base proximate said substantially planar upper region.

19. The I-joist jig as claimed in claim 18 wherein said means for aligning includes a protrusion extending generally downwardly and away from said shoulder proximate a second end region of said support base wherein said second end region is disposed substantially perpendicular to said first end region.

20. The I-joist jig as claimed in claim 19 further including means for adjusting a distance between said shoulder and a distalmost edge from said shoulder.
